(19) United States
(12) Patent Application Publication
(10) Pub. No.: US 2017/0220970 A1
(43) Pub. Date: Aug. 3, 2017

(54) STORAGE AREA MANAGEMENT SYSTEM AND STORAGE AREA MANAGEMENT METHOD

(71) Applicant: Hitachi, Ltd., Tokyo (JP)

(72) Inventor: Yoriko KAZAMA, Tokyo (JP)

(21) Appl. No.: 15/334,678

(22) Filed: Oct. 26, 2016

(30) Foreign Application Priority Data
Feb. 2, 2016 (JP) 2016-018186

(51) Int. Cl. G06Q 10/06; G06Q 10/08

(52) U.S. Cl. CPC G06Q 10/06315; G06Q 10/083

(57) ABSTRACT

Convenience when a customer obtains merchandise is improved together with reduction in a delivery cost of the merchandise. There is provided a storage unit that holds storage area information on positions of plural storage areas and user information on action characteristics of plural users; a storage area extraction unit that extracts plural storage areas available for the respective users on the basis of the action characteristics of the plurality of users and the plurality of storage areas; a placement position determination unit that determines a storage area in which merchandise predicted to be purchased by each of the users is placed from the plurality of storage areas available for the respective users; and a delivery instruction creation unit that creates and transmits an instruction for delivering the merchandise predicted to be purchased by each of the users to the storage area determined by the placement position determination unit.

### CLAIM OF PRIORITY

The present application claims priority from Japanese patent application JP 2016-018186 filed on Feb. 2, 2016, the content of which is hereby incorporated by reference into this application.

### BACKGROUND

The present invention relates to the storage of merchandise and a purchasing system of the merchandise.

A technique has been published in which in sales by online order, a predetermined article is stocked in a hub close to a customer's position on the basis of information on order histories and purchase locations of the subject customer and the other customers, and the like before the customer's order, and the article is delivered to the subject customer from the hub after the order (for example, U.S. Pat. No. 8,615,473).

### SUMMARY

If the customer is absent at the time of delivering the ordered article to a customer's house, a re-delivery for again delivering the same article to the house at another date and time occurs, resulting in a high cost of the delivery. For that reason, it is conceivable to combine a stock system for going get the article at a place specified by the customer with the invention disclosed in the above U.S. Pat. No. 8,615,473. However, in that case, there is a need to deliver the article to the place specified by the customer from the hub, and it takes a long time for the customer to get the article. In addition, when predetermined merchandise is stocked in the hub as close to the customer's position as possible, the number of stocked pieces of merchandise is limited by a capacity of the hub.

In order to solve the above problem, one aspect of the present invention includes a storage unit that holds storage area information on positions of plural storage areas and user information on action characteristics of plural users; a storage area extraction unit that extracts plural storage areas available for the respective users on the basis of the action characteristics of the plurality of users and the plurality of storage areas; a placement position determination unit that determines a storage area in which merchandise predicted to be purchased by each of the users is placed from the plurality of storage areas available for the respective users; and a delivery instruction creation unit that creates and transmits an instruction for delivering the merchandise predicted to be purchased by each of the users to the storage area determined by the placement position determination unit.

According to the aspect of the present invention, there is no need to deliver the merchandise, and a deliver cost can be reduced. The customer can obtain the merchandise at a desired place at a desired timing.

### BRIEF DESCRIPTION OF THE DRAWINGS

FIG. 1 is an illustrative view of a distribution system to which a virtual backyard management system is applied according to a first embodiment of the present invention;

FIG. 2 is an illustrative view of a backyard group configuring the distribution system according to the first embodiment of the present invention;

FIG. 3 is a functional block diagram illustrating a configuration of the virtual backyard management system according to the first embodiment of the present invention;

FIG. 4 is a block diagram illustrating a hardware configuration of the virtual backyard management system according to the first embodiment of the present invention;

FIG. 5 is an illustrative view of a user information table included in a DB according to the first embodiment of the present invention;

FIG. 6 is an illustrative view of a merchandise information table included in a DB according to the first embodiment of the present invention;

FIG. 7 is an illustrative view of a backyard information table included in a DB according to the first embodiment of the present invention;

FIG. 8 is a functional block diagram illustrating a configuration of a virtual backyard management system according to a second embodiment of the present invention;

FIG. 9 is a flowchart illustrating a process to be executed by the virtual backyard management system according to the second embodiment of the present invention;

FIGS. 10A and 10B are illustrative views of a UI provided by the virtual backyard management system according to the second embodiment of the present invention; and

FIG. 11 is an illustrative view of a process for extracting a backyard group in which merchandise is placed by a virtual backyard management system according to a third embodiment of the present invention.

### DETAILED DESCRIPTION

### First Embodiment

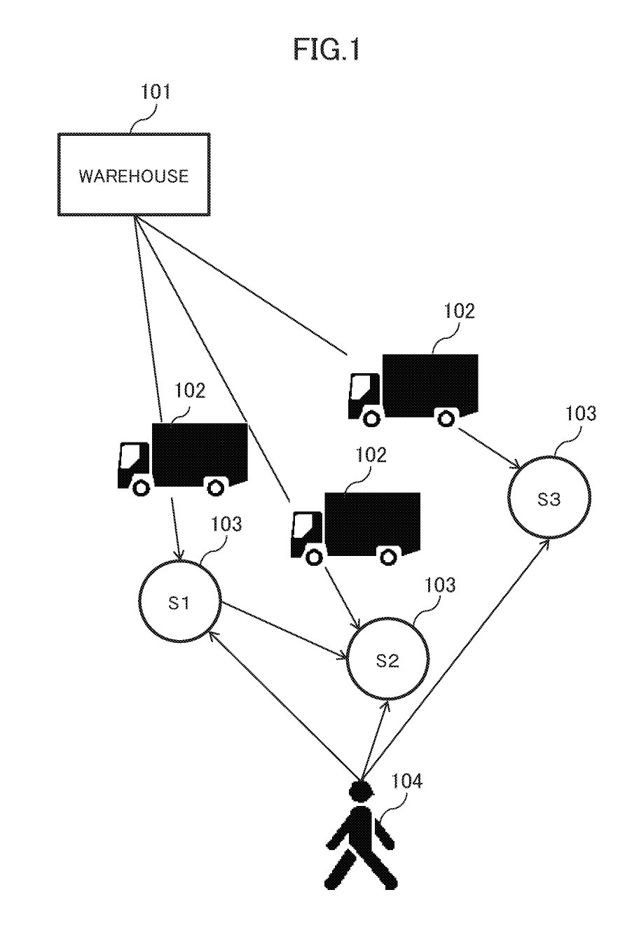

FIG. 1 is an illustrative view of a distribution system to which a virtual backyard management system is applied according to a first embodiment of the present invention.

In a distribution system illustrated in FIG. 1, merchandise predicted to be purchased by a user 104 among pieces of merchandise stored in a warehouse 101 is delivered to a store 103 available for the user 104 by a delivery vehicle 102, and stored. In this example, the store 103 available for the user 104 represents a store that can be directly visited by the user 104 to receive the merchandise, and in other words, the store 103 is a store that can be accessed by the user 104 such as the store 103 that is located at a position close to a house of the user 104 at which the user 104 easily stops.

When the user 104 orders the merchandise to be purchased, the user 104 receives information indicative of the store 103 in which the merchandise is stored, and can go to any store 103 according to the received information to purchase the merchandise. Although not shown in FIG. 1, the virtual backyard management system performs a series of processes for predicting the merchandise to be purchased by the user, instructing to deliver the merchandise to the store 103 available for the user on the basis of the prediction, transmitting information on the store 103 in which the merchandise is stored according to a user's order, and so on. In the present embodiment, among those processes, processes until the merchandise predicted to be purchased by the user is delivered to the store 103 will be described.

FIG. 1 illustrates one warehouse 101, but multiple warehouses 101 may be provided actually. The multiple stores 103 are included in the distribution system of the present embodiment but the number of stores 103 is not limited to three illustrated in FIG. 1, but is arbitrary. In general, a large number of stores 103 are present. Likewise, the number of delivery vehicles 102 and the number of users 104 are also arbitrary, but in general, a large number of delivery vehicles 102 and a large number of users 104 are present.

The merchandise delivered to each store 103 is stored in a storage area (so-called backyard) of each store 103 until the merchandise is delivered to the user 104 who wants to purchase the merchandise according to the user's order. Symbols “S1” and so on displayed in the respective stores 103 of FIG. 1 represent identification numbers of the respective stores 103. In the following description, the store 103 may be called “backyard 103”. For example, the store 103 identified by “S1” may be called “store S1” or “backyard S1”.

An example of the warehouse 101 is a suburban large-scale distribution warehouse which can store a sufficient amount of merchandise in order to respond to the order of the user 104. On the other hand, an example of each store 103 is a retail store such as a convenience store, and the amount of storable merchandise is limited. For that reason, just one store 103 cannot store a sufficient amount of merchandise in order to respond to the orders from all of the users 104 who can use such a store 103. However, normally, the number of stores 103 available for one user 104 is not only one. For example, when one user 104 can use multiple stores 103 (for example, stores S1 to S3 in FIG. 1) in the neighborhood of a residence or an office location of the user 104, if a stock is present in any one of those stores 103, the user 104 can obtain the merchandise without significantly impairing the convenience. In the present embodiment, in order to compensate for an insufficient capacity of a storage area of each store 103, a backyard group configured by the storage areas of the multiple stores 103 can be treated as one virtual backyard.

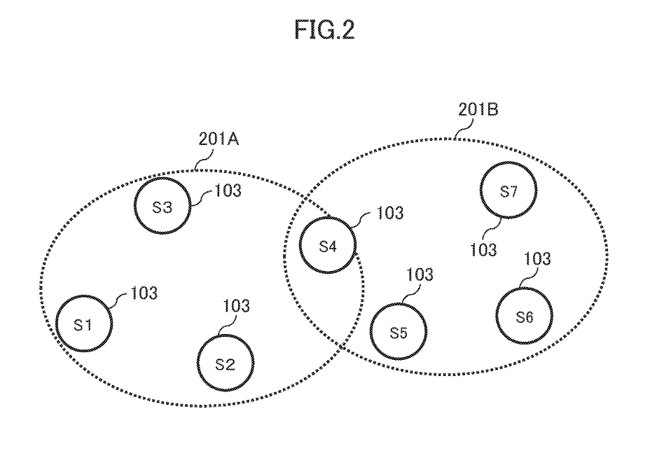

FIG. 2 is an illustrative view of a backyard group configuring the virtual backyard according to the first embodiment of the present invention.

FIG. 2 illustrates an example of a geographic location of seven stores 103 including S1 to S7. In this example, the stores S1 to S4 geographically close to each other are set as one backyard group 201A, and likewise, the stores S4 to S7 geographically close to each other are treated as another backyard group 201B. In the following description, when there is no need to distinguish the respective backyard groups 201A and 201B from each other, those backyard groups may be collectively called “backyard group 201”. As with the store S4, one store 103 may belong to the multiple backyard groups 201.

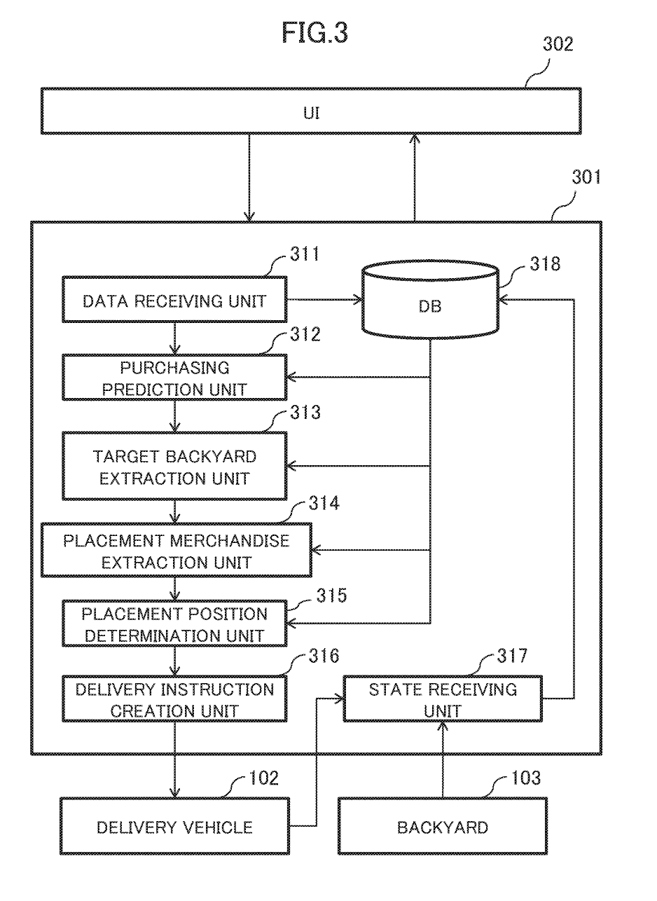

FIG. 3 is a functional block diagram illustrating a configuration of the virtual backyard management system according to the first embodiment of the present invention.

A virtual backyard management system 301 according to the present embodiment includes a data receiving unit 311, a purchasing prediction unit 312, a target backyard extraction unit 313, a placement merchandise extraction unit 314, a placement position determination unit 315, a delivery instruction creation unit 316, a state receiving unit 317, and a database (DB) 318. Processes executed by the above respective units and data stored in the DB 318 will be described later.

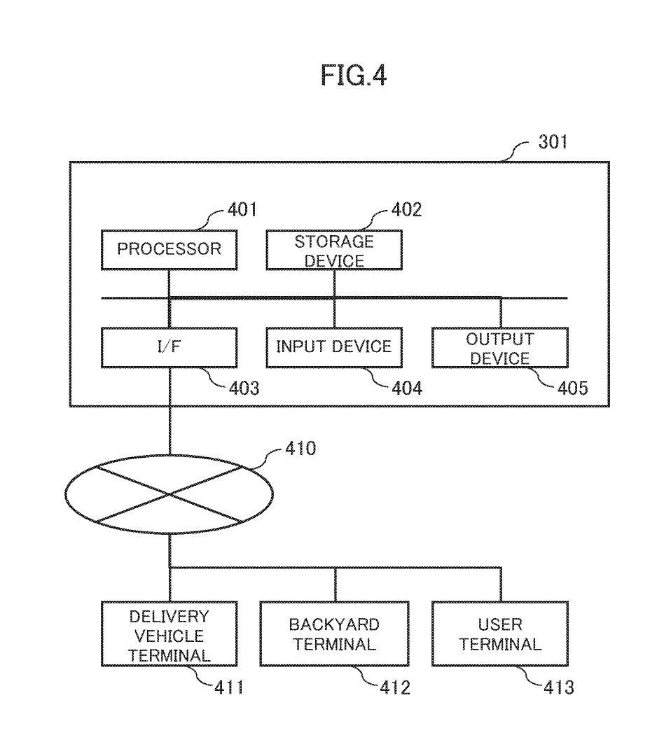

FIG. 4 is a block diagram illustrating a hardware configuration of the virtual backyard management system according to the first embodiment of the present invention.

The virtual backyard management system 301 according to the present embodiment includes a processor 401, a storage device 402, a network interface (I/F) 403, an input device 404, and an output device 405 which are connected to each other.

The processor 401 executes a program stored in the storage device 402 to realize the processes of the respective units illustrated in FIG. 3. In the following description, the processes executed by the respective units such as the data receiving unit 311 to the state receiving unit 317 are actually executed by allowing the processor 401 to control the storage device 402, the I/F 403, the input device 404, the output device 405, and so on according to a command described in the program as needed.

The storage device 402 stores date and the like used for the program executed by the processor 401 and the process by the processor 401. The DB 318 illustrated in FIG. 3 is stored in the storage device 402. The storage device 402 may include, for example, a main storage device including a semiconductor memory and an auxiliary storage device including a hard disk drive and so on.

The I/F 403 is connected to a network 410, and performs data communication with another equipment through the network 410. The network 410 is connected with a delivery vehicle terminal 411 installed in the delivery vehicle 102, a backyard terminal 412 installed in the backyard 103, and a user terminal 413 used by the user 104. Because hardware configurations of those terminals may be identical with, for example, those illustrated in FIG. 4, their description will be omitted.

The input device 404 is configured by a device that receives an input from a manager of the system, such as a keyboard and a mouse. The output device 405 is configured by an image display device that outputs information to the manager of the system.

The virtual backyard management system 301 according to the present embodiment can be installed in an arbitrary place. For example, the virtual backyard management system 301 may be installed in the warehouse 101, any backyard 103, or a place other than those places.

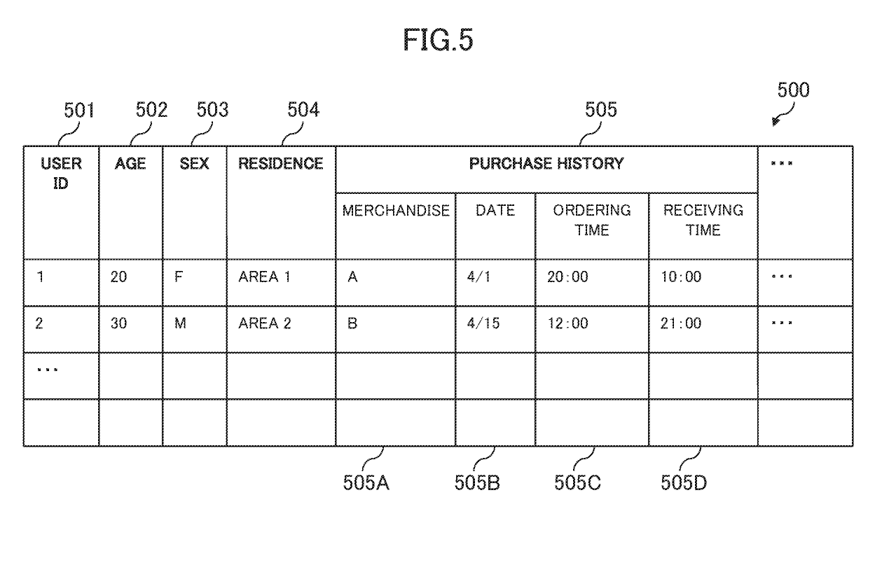

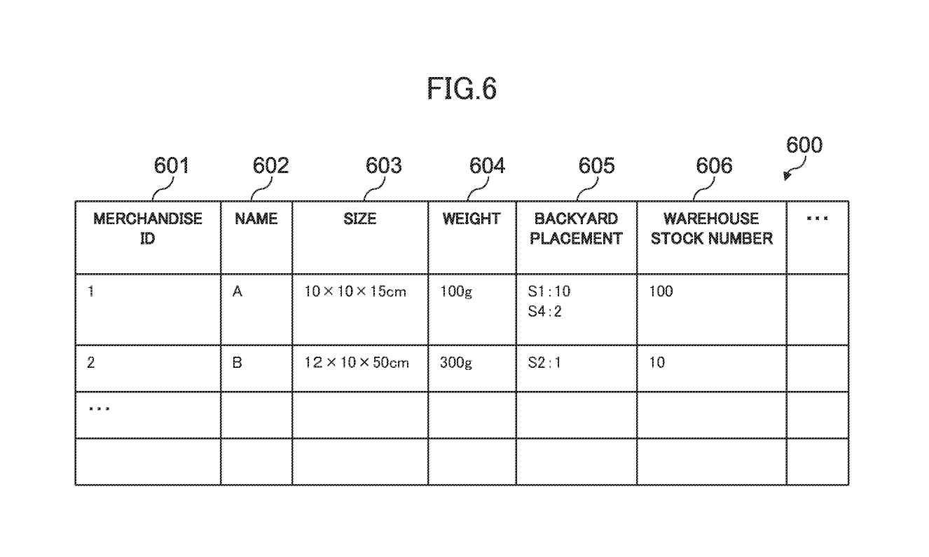

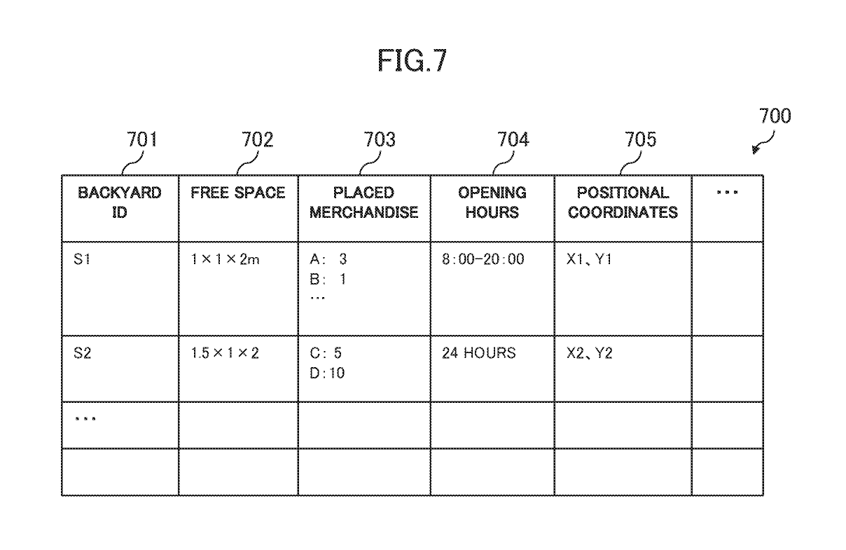

Subsequently, the information included in the DB 318 will be described. The DB 318 according to the present embodiment includes at least a user information table (FIG. 5) including information on the user who has purchased the merchandise, a merchandise information table (FIG. 6) including information on the merchandise stored in the warehouse 101 or the like, and a backyard information table (FIG. 7) including information on each backyard 103.

FIG. 5 is an illustrative view of a user information table 500 included in the DB 318 according to the first embodiment of the present invention.

The user information table 500 includes a user ID 501 for identifying each user 104, an age 502 of each user, a sex 503 of each user, a residence 504 of each user, and a purchase history 505 of each user, and so on. The purchase history 505 includes, for example, merchandise 505A indicative of an item of the merchandise purchased by each user, a date 505B indicative of a date and a time when ordering the purchase, an ordering time 505C, a receiving time 505D indicative of a time when each user has received the merchandise, and so on. Incidentally, the residence 504 may represent a coordinate value of a user's house or address information including a place name, an address, and so on to which the house belongs, or identification information (for example, city name, town name, or the like) of an area to which the house belongs.

In this example, the residence 504 is an example of information indicative of the action characteristic of the user 104, and the user information table 500 may include information indicative of another action characteristic. Such information includes, for example, information on an office location, a commuting route, and a major stop destination (for example, nearest station, commercial facilities the user frequently visits, or the like) of the user 104. Further, each location may include information on a time zone when the user 104 is highly likely to stay.

FIG. 6 is an illustrative view of a merchandise information table 600 included in the DB 318 according to the first embodiment of the present invention.

The merchandise information table 600 includes a merchandise ID 601 for identifying the items of the merchandise, a name 602 of the merchandise of each item, a size 603, a weight 604, a backyard placement 605 indicative of the number of pieces of merchandise placed in each backyard 103 at the current time among the merchandise of each item, a warehouse stock number 606 indicative of the number of stocked pieces of merchandise of each item in the warehouse 101 at the current time, and so on. The backyard placement 605 includes the number of placed pieces of merchandise of each item in each backyard 103.

FIG. 7 is an illustrative view of a backyard information table 700 included in the DB 318 according to the first embodiment of the present invention.

The backyard information table 700 includes a backyard ID 701 for identifying each backyard 103, a free space 702 indicative of a volume of a space available for storing the merchandise in each backyard 103, placed merchandise 703 indicative of the item and quantity of the merchandise placed in each backyard 103 at the current time, opening hours 704 indicative of a time when the merchandise can be loaded and received in each backyard 103, positional coordinates 705 indicative of a position of each backyard 103, and so on.

The capacity of the remaining free space in which the merchandise is not yet placed (in other words, the merchandise can be placed from now) in the total capacity (free space) of each backyard 103 can be calculated on the basis of the free space 702, the placed merchandise 703, and the backyard placement 605 of the merchandise information table 600.

The backyard information table 700 may further include identification information of the backyard group to which each backyard 103 belongs. When one backyard 103 belongs to the multiple backyard groups, identification information on those multiple backyard groups is held.

Subsequently, a process to be executed by each unit of the virtual backyard management system 301 illustrated in FIG. 3 will be described.

First, when the data receiving unit 311 receives the order of the purchase of the merchandise from the user 104 through a user interface (UI) 302, the data receiving unit 311 stores the received information in the DB 318 as a purchase history. The UI 302 includes, for example, an operation screen for the user to purchase the merchandise, and is provided to the user from the virtual backyard management system 301 through the user terminal 413. In addition, the information received by the data receiving unit 311 includes at least information for identifying the item of the merchandise wished to be purchased by the user 104.

Next, the purchasing prediction unit 312 predicts a future purchasing trend of the merchandise by each user 104 on the basis of the purchasing history stored in the DB 318. For example, the purchasing prediction unit 312 may predict the item, the quantity, a time, and so on of the merchandise to be purchased by each user 104 in the future. Because such a prediction may be performed by any method such as the method disclosed in U.S. Pat. No. 8,615,473, its description will be omitted.

Next, the target backyard extraction unit 313 extracts the backyard group in which the merchandise predicted by the purchasing prediction unit 312 is placed in advance from the multiple backyard groups. In this example, the target backyard extraction unit 313 may extract the backyard group on the basis of whether or not each user 104 can use the store 103 included in each backyard group. In this situation, the number of backyard 103, the ease of an access to each available backyard 103, the size of the space remaining in each available backyard 103, and so on may be considered.

For example, the target backyard extraction unit 313 may specify one or more backyards 103 available for one user 104, and extract any one of one or more backyard groups including one or more specified backyards as the backyard group in which the merchandise predicted to be purchased by the user 104 is placed. Alternatively, when one user 104 can use all of the backyards 103 belonging to one backyard group, the target backyard extraction unit 313 may specify such a backyard group as the backyard group available for the user 104, and extract any one of the one or more available backyard groups thus specified as the backyard group in which the merchandise predicted to be purchased by the user 104 is placed. Alternatively, the target backyard extraction unit 313 may extract the backyard group including a largest amount of backyard 103 available for one user 104, the backyard group including the backyard 103 closest to the user 104, or the backyard group large in the remaining space. The above process is performed on all of the users 104, to thereby associate all of the merchandise predicted to be purchased with the backyard groups in which that merchandise is placed.

Whether the user 104 can use each backyard 103 or not may be determined on the basis of a relationship between the residence 504 of each user 104 and the positional coordinates 705 of each backyard 103. For example, when a travel distance from the residence of one user 104 to one backyard 103 is smaller than a predetermined value, it may be determined that the user 104 can use the backyard 103. Alternatively, the travel time from the residence of one user 104 to one backyard 103 may be calculated on the basis of map information, and when the travel time is smaller than the predetermined value, it may be determined that the user 104 can use the backyard 103. When the information on the stop destination (for example, office location, nearest station, and so on) of the user is available, the same determination as that described above may be performed on the basis of the position of the stop destination.

Incidentally, the multiple backyard groups to be processed by the target backyard extraction unit 313 may be generated by some method in advance, may be generated every time the target backyard extraction unit 313 performs the processing, or the target backyard extraction unit 313 may be changed at an appropriate timing. Those multiple backyard groups may be generated by any method, but may be generated, for example, according to the distribution of the residence of the multiple users 104 serviced by the virtual backyard management system 301. For example, in a region where the density of the users is high, because the quantity stored in the backyard group is increased, the backyard group including a large number of backyards 103 may be generated.

Next, the placement merchandise extraction unit 314 determines the merchandise (for example, how many pieces of merchandise of any item is placed in each extracted backyard group) actually placed in the extracted backyard group among the merchandise predicted to be purchased on the basis of the capacity of the free space of the extracted backyard group. For example, the placement merchandise extraction unit 314 may compare a total of the volumes of the free spaces 702 of all the backyards 103 belonging to each backyard group with a total of the volumes of all the merchandise associated with each backyard group by the target backyard extraction unit 313, and determine the amount of placed amount so that the comparison result satisfies a predetermined condition. For example, when a total of the remaining portions of the free spaces 702 is equal to or more than a total of the volumes of all the merchandise, because all of the purchase can be stored in the free spaces, all of the merchandise may be determined as the merchandise placed in the extracted backyard group. In this situation, the determination may be performed so that a predetermined amount of margin remains in the free space. Incidentally, a volume of the merchandise can be calculated from the size 603 of each piece of merchandise included in the merchandise information table 600.

When the backyard groups overlap with each other as illustrated in FIG. 2, the free space of the backyard 103 belonging to the multiple backyard groups is divided and allocated to the respective backyard groups in advance, and the above comparison may be performed according to the total of the free spaces allocated to the respective backyard groups. Alternatively, the above comparison of the respective backyard groups may be performed in a predetermined order (for example, the order of the amount of associated merchandise, the order of the number of associated users, the order of the number of belonging backyards, or the like).

As a result of the above comparison, in the case where the total of the free spaces is smaller than the total of all the merchandise, or in the case where a predetermined amount of margin does not remain in the free space when all of the merchandise is placed, because all of the merchandise cannot be stored in the free space, the placement merchandise extraction unit 314 determines some of all the specified merchandise as the merchandise actually placed in the extracted backyard group. In this situation, the placement merchandise extraction unit 314 may determine the merchandise that is highly likely to be purchased as the merchandise actually placed preferentially. For example, the placement merchandise extraction unit 314 may determine the merchandise predicted to be purchased by a large number of users as the merchandise actually placed preferentially.

Next, the placement position determination unit 315 determines the placement position (for example, how many pieces of merchandise of any item is placed in any backyard 103 included in the backyard group) of the merchandise determined by the placement merchandise extraction unit 314. For example, the placement position determination unit 315 may determine the placement position of the merchandise so that the merchandise predicted to be purchased by each user 104 is placed in the backyard 103 available for the user. Alternatively, the placement position determination unit 315 may determine the placement position of the merchandise so that a larger number of pieces of merchandise is placed in the backyard 103 available for a larger number of users 104.

Next, the delivery instruction creation unit 316 transmits an instruction for delivering each piece of merchandise to the placement position determined by the placement position determination unit 315 to each delivery vehicle 102. Each delivery vehicle 102 delivers the merchandise to each backyard 103 according to the instruction. The delivery vehicle terminal 411 of each delivery vehicle 102 transmits the delivery result to the virtual backyard management system 301. Also, in each backyard 103, as a result of adding the merchandise from the delivery vehicle 102 or delivering the stored merchandise to the user 104, when the amount of stored merchandise is varied, the backyard terminal 412 transmits a notice of the variation to the virtual backyard management system 301.

The state receiving unit 317 of the virtual backyard management system 301 updates the DB 318 (in particular, placed merchandise 703, backyard placement 605, receiving time 505D, and so on) on the basis of the information received from the delivery vehicle terminal 411 and the backyard terminal 412.

According to the first embodiment of the present invention described above, the merchandise is placed close to the residence of the user predicted to purchase the merchandise in advance (in other words, before the merchandise is ordered by the user). For that reason, the user can easily acquire the merchandise in a short time after having ordered the merchandise.

### Second Embodiment

Next, a second embodiment of the present invention will be described. In the first embodiment, the process until the merchandise predicted to be purchased by the user is delivered to the backyard 103 has been described. In a second embodiment, a process for transmitting information on a store 103 in which merchandise is stored according to an order from the user will be further described. Except for differences described below, because the respective parts of a system in the second embodiment have the same functions as those in the respective parts denoted by identical reference numerals or symbols in the first embodiment illustrated in FIGS. 1 to 7, a description of those parts will be omitted.

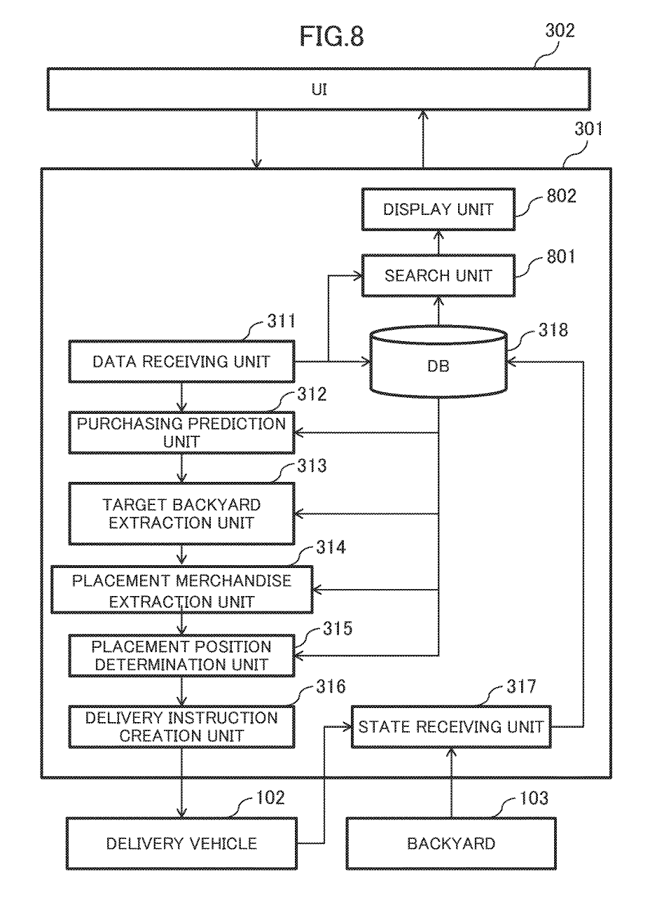

FIG. 8 is a functional block diagram illustrating a configuration of a virtual backyard management system according to the second embodiment of the present invention.

A virtual backyard management system 301 according to the present embodiment is identical with the virtual backyard management system 301 in the first embodiment except that a search unit 801 and a display unit 802 are further provided. As with the data receiving unit 311 to the state receiving unit 317, in the following description, the processor 401 actually executes processes to be executed by the search unit 801 and the display unit 802 according to a program stored in a storage device 402.

A user 104 operates a user terminal 413 to input an order for purchasing merchandise. For example, the user terminal 413 may output an UI 302 including a screen for purchasing the merchandise provided by the virtual backyard management system 301, and the user 104 may operate the UI 302 to enter the order. The user terminal 413 transmits at least ordering information including an item of the merchandise to be purchased by the user 104 and the quantity of merchandise.

The data receiving unit 311 to the state receiving unit 317 of the virtual backyard management system 301 execute the same process as that described in the first embodiment on the basis of the received ordering information.

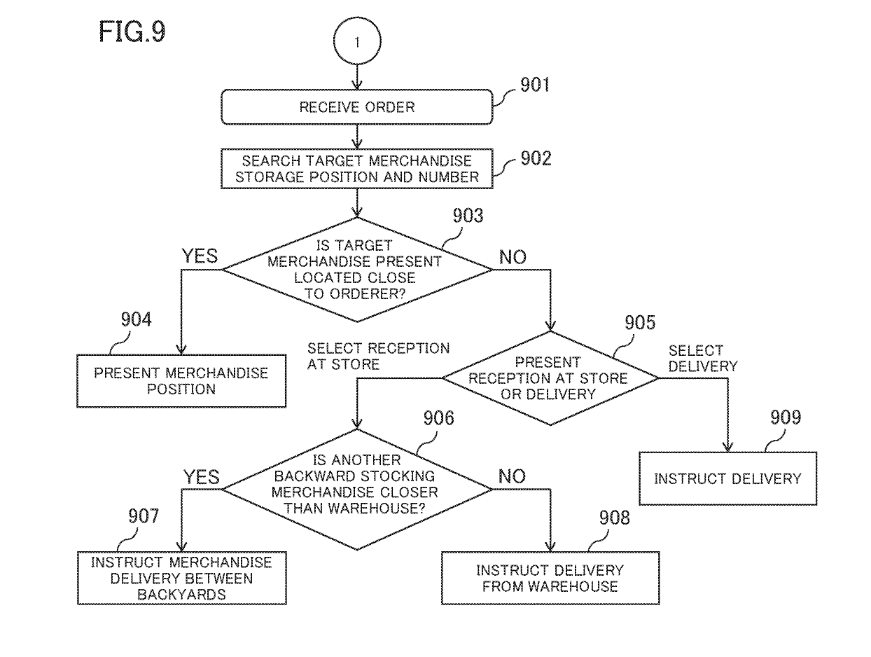

Further, in the present embodiment, the search unit 801 and the like execute a process of searching and outputting the information on the ordered merchandise. The process will be described with reference to FIG. 9.

FIG. 9 is a flowchart illustrating a process to be executed by the virtual backyard management system according to the second embodiment of the present invention.

When the data receiving unit 311 receives ordering information from the user 104 (Step 901), the search unit 801 searches the ordered merchandise (hereinafter referred to as “target merchandise”) from the merchandise information table 600 (Step 902). Specifically, the search unit 801 specifies the backyard 103 in which the target merchandise is placed with reference to the backyard placement 605 corresponding to the target merchandise, and further specifies the number of merchandise placed in each backyard.

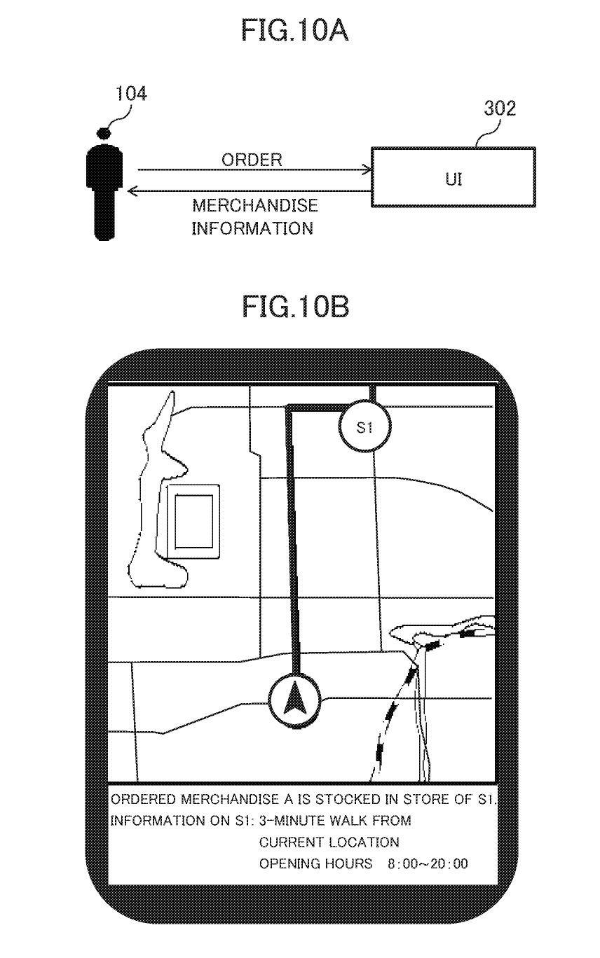

Next, the search unit 801 determines whether or not the ordered number of target merchandise is placed in the backyard 103 available for the ordering user 104 (Step 903), and if the ordered number of target merchandise is placed, the display unit 802 outputs information indicative of a position of the backyard 103 (Step 904). For example, as will be described later, the display unit 802 may generate a map image indicative of a route from the current position (for example, residence) of the user 104 to the specified backyard 103 to transmit the generated map image to the user terminal 413, and the user terminal 413 may display the UI 302 including the map image (refer to FIG. 10B).

In this example, the search unit 801 can specify the backyard 103 available for the ordering user 104 in the same method as the process executed by the target backyard extraction unit 313. For example, the search unit 801 may specify the available backyard 103 on the basis of a distance from the residence, the nearest station or the office location of the user 104. As a result, when the multiple backyards 103 close to each of the residence, the nearest station, and the office location are specified, the display unit 802 may sequentially display information on those backyards 103. Further, when the information indicative of a stay time zone of the user 104 in each place is available, the display unit 802 may estimate a place where the user 104 is highly likely to stay in a time zone including a time at which the order is performed on the basis of the above information as the current residence of the user 104, and output the information on the backyard 103 closer from the residence preferentially. Further, for example, when the information indicative of the current residence of the user 104 is available by a GPS (global positioning system) function of the user terminal 413 or the like, the search unit 801 may search the available backyard 103 from the residence.

Incidentally, the search unit 801 may add information indicating that the merchandise placed in the backyard 103 provided to the user in Step 904 has been reserved by the user 104 who has ordered the merchandise to the DB 318. For example, in an example of FIG. 6, ten pieces of merchandise (hereinafter referred to as “merchandise A”), a name of which is “A” is placed in a backyard S1. In this example, when one piece of merchandise A is ordered by the user who can use the backyard S1, a position of the backyard S1 is transmitted to the user 104. Further, the search unit 801 may add information indicating that one piece of merchandise A has been reserved to information indicating that ten pieces of merchandise A are placed in the backyard S1, which has been registered in the backyard placement 605 of the merchandise information table 600. With the above configuration, one piece of merchandise A is ensured so as not to be delivered to another user 104, and surely delivered to the ordering user 104.

When it is determined that the ordered number of pieces of target merchandise is not placed in the backyard 103 available for the ordering user 104, the search unit 801 presents an option for allowing the user 104 to select any of the store receipt and the delivery (Step 905). For example, the display unit 802 may generate an image including such an option to transmit the generated image to the user terminal 413, and the user terminal 413 may display the UI 302 including the option.

When the store receipt is selected by the user, the search unit 801 determines which of another backyard 103 and the warehouse 101 in which the target merchandise is placed is closer to the backyard 103 available for the user, with reference to the merchandise information table 600 and the backyard information table 700 (Step 906).

When it is determined in Step 906 that another backyard is closer, the search unit 801 transmits an instruction for delivering the target merchandise from another backyard 103 in which the target merchandise is placed to the backyard 103 available for the user (Step 907). When it is determined in Step 906 that the warehouse 101 is closer, the search unit 801 transmits an instruction for delivering the target merchandise from the warehouse 101 to the backyard 103 available for the user (Step 908).

When the delivery is selected in Step 905, the search unit 801 transmits an instruction for delivering the target merchandise, for example, from another backyard 103 in which the target merchandise is placed, or from the warehouse 101 to the residence (for example, home) of the user (Step 909).

Incidentally, the instructions in Steps 907 to 909 may be created, for example, by the delivery instruction creation unit 316, and transmitted to any delivery vehicle 102.

When the number of pieces of merchandise placed in each backyard 103 is changed due to the above processes, the backyard terminal 412 of each backyard 103 transmits information indicative of the change in the number of pieces of merchandise to the virtual backyard management system 301. A state receiving unit 317 of the virtual backyard management system 301 updates the DB 318 on the basis of the received information. With this update, a latest state of each backyard 103 is reflected in the DB 318.

FIGS. 10A and 10B are illustrative views of the UI 302 provided by the virtual backyard management system according to the second embodiment of the present invention.

As illustrated in FIG. 10A, information on the order of the merchandise by the user 104 and the ordered merchandise is presented through the UI 302.

FIG. 10B illustrates an example of the merchandise information presented to the user in Step 904 of FIG. 9. In this example, a map image showing a route from the residence (for example, home) of the user 104 to the store S1 in which the ordered merchandise is placed is displayed, and a time required to move to the store S1, opening hours of the store S1, and so on are further displayed. Referring to those pieces of information, the user 104 can go to the neighborhood store S1, and purchase desired merchandise.

According to the second embodiment of the present invention described above, the store that is easily used by the user among the stores in which the merchandise is placed is presented according to the user's order whereby the user is capable of visiting the store and receiving the merchandise. As a result, the user can obtain the desired merchandise immediately, and reduce the delivery cost.

In addition, in the above description, an example in which the store in which the merchandise is stored is presented on the basis of the ordering information with the user's order as a trigger has been described. Alternatively, the storage store of the merchandise may be presented with not the user's order but the user's operation on the online site in which the merchandise information is published as the trigger. Specifically, a time when the number of times, a clock time, or a time when the user has browsed the merchandise exceeds a criterion for determination that the user is interested in the merchandise is set as the trigger. In addition, a time when introduction information on the merchandise is published in the information side the user frequently browses may be set as the trigger. As timing when presenting the merchandise stock information, not only an active behavior from the user who orders, but also the stock information is presented with determination as the interesting merchandise even if an explicit action to order is not shown, thereby being capable of promoting a potential purchasing behavior.

### Third Embodiment

Next, a third embodiment of the present invention will be described. Except for differences described below, because the respective parts of a system in the third embodiment have the same functions as those in the respective parts denoted by identical reference numerals or symbols in the first or second embodiment illustrated in FIGS. 1 to 10B, a description of those parts will be omitted.

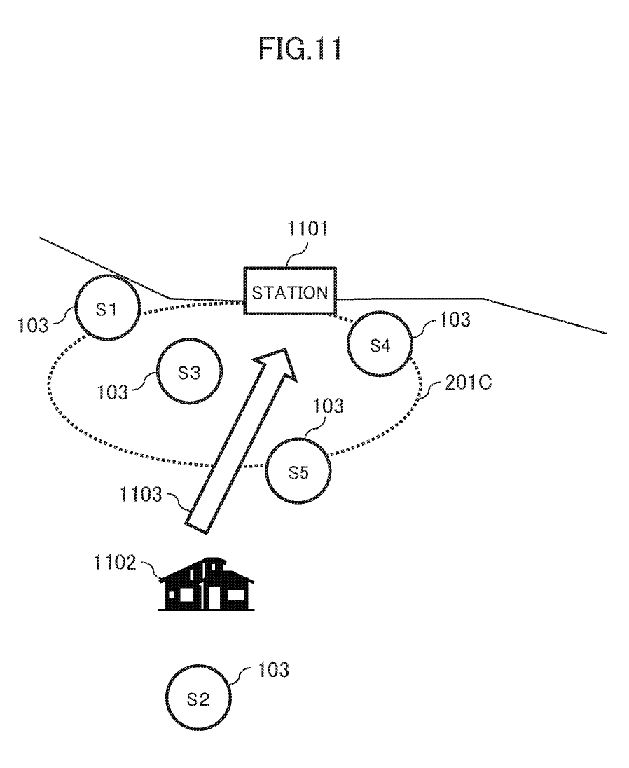

FIG. 11 is an illustrative view of a process for extracting a backyard group in which merchandise is placed by a virtual backyard management system according to the third embodiment of the present invention.

The target backyard extraction unit 313 according to the first embodiment extracts the backyard group 201 in which the merchandise is placed on the basis of the geographical space distance (for example, distance, travel time, and so on). On the contrary, a target backyard extraction unit 313 of the present embodiment extracts a backyard group 201 with weighting a traffic hub. For example, the target backyard extraction unit 313 may extract the backyard group 201 so that even if the distance from a home 1102 is the same, the backyard group 201 including a backyard 103 in direction closer to a direction from the home toward a station frequently used by the user 104 is likely to be extracted, but the backyard group 201 including the backyard 103 in the opposite direction is unlikely to be extracted.

Specifically, for example, a user information table 500 may include not only the residence (for example, home 1102) of the user 104 but also information indicative of the position of a nearest station 1101. In that case, when the target backyard extraction unit 313 determines the backyard 103 available for the user 104, the target backyard extraction unit 313 may weight the distance or the travel time from the home 1102 of the user 104 to each delivery vehicle 102 according to a distance between a direction 1103 from the home 1102 to the nearest station 1101 and a direction from the home 1102 to each backyard 103, so that the backyard 103 in the direction closer to a direction 1103 from the home 1102 to the nearest station 1101 is likely to be determined to be available. With the above configuration, even in the backyard group including the backyards 103 having the same distance from the nearest station 1101, the backyard group 201 (for example, a backyard group 201C including a backyard S5 in FIG. 11) including the backyard 103 in the direction close to the direction 1103 from the home to the nearest station is likely to be extracted, and the backyard group 201 (not shown) including the backyard 103 in the direction far from the direction 1103 is unlikely to be extracted.

Further, when the user information table 500 includes information indicative of a place high in frequency where the user is present, or a route high in frequency where the user uses, such as a commuting route of the user 104 or the like, the target backyard extraction unit 313 may weight the place or the route according to a distance from such a place or route. When the commuting route includes a station in which the user 104 performs a transfer and other stations, the weighting may be performed so that the backyard 103 short in the distance from the station where the user 104 performs the transfer is likely to be determined to be available.

Further, when the user information table 500 includes information indicative of whether the user 104 can use an automobile or not, the weighting may be changed according to such information. For example, the weighting may be performed so that even a farther backyard 103 is likely to be determined to be available for the user 104 who can use the automobile.

According to the third embodiment of the present invention described above, because the merchandise predicted to be purchased by the user 104 is likely to be placed in the backyard 103 available for the user 104, the convenience of the user is improved.

### Fourth Embodiment

Next, a fourth embodiment of the present invention will be described. A virtual backyard management system 301 according to the present embodiment replaces the merchandise placed in a store with another, from the viewpoints of a stock situation of the store and an actual purchasing trend of the customer. Further, the virtual backyard management system 301 according to the present embodiment changes a configuration of a backyard group according to an increase or decrease of the number of users 104 and a change in an action characteristic of each user 104. Except for differences described below, because the respective parts of a system in the fourth embodiment have the same functions as those in the respective parts denoted by identical reference numerals or symbols in the first to third embodiments illustrated in FIGS. 1 to 11, a description of those parts will be omitted.

A purchasing prediction unit 312 to a placement position determination unit 315 according to the present embodiment compares, for example, a past prediction with the current prediction or records up to now, and when a deviation between those predictions is larger than a predetermined value, the purchasing prediction unit 312 to the placement position determination unit 315 may indicate the receipt of the merchandise from each backyard 103 or the addition of the merchandise to each backyard 103. More specifically, for example, the placement position determination unit 315 determines the number of pieces of certain merchandise placed in a certain backyard group on the basis of the prediction performed by the purchasing prediction unit 312 at a certain time. When a difference between the number of pieces of merchandise and the number determined on the basis of the subsequent prediction is larger than a predetermined value, or when a difference between the predicted number and the number of pieces of merchandise actually purchased is larger than the predetermined value, the merchandise may be taken off from each backyard 103 of the backyard group into the warehouse 101, or may be restocked from the warehouse 101 into each backyard 103, to thereby eliminate the deviation between those components.

Further, the target backyard extraction unit 313 according to the present embodiment may change the setting of the backyard group 201 according to a change in the action characteristics such as the residence, the office location, the commuting route, and the activity time zone of the user 104. For example, when the number of user 104 using the backyard group 201 in a certain region is increased, the setting may be changed so that the backyard group 201 in that region includes a larger number of backyards 103.

According to the fourth embodiment of the present invention described above, unnecessary stock is eliminated, and the merchandise that is high likely to be purchased is placed on the basis of the latest prediction. Further, the backyard of an appropriate scale is set so that the deficiency of the merchandise to be delivered to the user 104 due to the short stock is prevented with an improvement in the convenience of the user.

### Fifth Embodiment

Next, a fifth embodiment of the present invention will be described. Except for differences described below, because the respective parts of a system in the fifth embodiment have the same functions as those in the respective parts denoted by identical reference numerals or symbols in the first to third embodiments illustrated in FIGS. 1 to 11, a description of those parts will be omitted.

In the first embodiment and so on, the purchasing prediction unit 312 predicts the future purchasing trend on the basis of the past actual purchasing history of the user 104. In this example, the purchasing history is an example of the action history of the user 104 which is available for the prediction of the future purchasing trend, and it is conceivable that the future purchasing trend can be predicted with the use of the other action histories. The purchasing prediction unit 312 according to the present embodiment predicts the future purchasing trend on the basis of the action histories (for example, access history of the user 104 to the merchandise information) other than the purchasing history.

More specifically, for example, the virtual backyard management system 301 may allow the user 104 to browse a purchase site of the merchandise through the UI 302, and when a history that the user 104 accesses the information on specific merchandise on the site satisfies a predetermined condition (for example, when the number of accesses exceeds a predetermined number, when an access time exceeds a predetermined length, or when a predetermined process is performed such that the merchandise is added to a shopping cart), the purchasing prediction unit 312 may predict that the user 104 purchases the merchandise in the future. The target backyard extraction unit 313 to the placement position determination unit 315 may execute the same process as that in the first embodiment according to the prediction, and determine the placement of the merchandise.

Alternatively, when the merchandise predicted to be purchased as described above is not placed in the backyard 103 available for the user 104, the placement position determination unit 315 according to the present embodiment may search the stock of the neighborhood backyard 103 with reference to the DB 318. When the stock of the merchandise is present, the placement position determination unit 315 may determine that the stock of the merchandise is delivered to the backyard 103 available for the user 104. When the stock is also absent in the neighborhood backyard 103, the placement position determination unit 315 may determine the delivery from the warehouse 101. The delivery instruction based on the determination is transmitted from the delivery instruction creation unit 316 to the delivery vehicle 102, and the delivery is performed.

As a result of the above delivery, when the merchandise is placed in the backyard 103 available for the user 104, or the merchandise has already been placed in the backyard 103, the display unit 802 may transmit the information indicating that the merchandise is present in the backyard 103 to the user terminal 413 of the user 104.

According to the fifth embodiment of the present invention described above, the purchasing trend of the user is predicted on the basis of the action of the user other than the past purchasing histories, and the placement of the merchandise based on the predicted purchasing trend is notified the user of, to thereby improve the convenience of the user.

### Sixth Embodiment

Next, a sixth embodiment of the present invention will be described. Except for differences described below, because the respective parts of a system in the sixth embodiment have the same functions as those in the respective parts denoted by identical reference numerals or symbols in the first to third embodiments illustrated in FIGS. 1 to 11, a description of those parts will be omitted.

In the first embodiment and the other embodiments, the merchandise is placed in the backyard or the like of the store. However, this configuration is merely an example of the storage area of the merchandise. Actually, the merchandise can be placed in the storage area of any kind so far as the free space in which the merchandise can be stored is present. As an example of the storage areas other than the backyard, a showcase without the shop, a vending machine, and a locker are applied. In the sixth embodiment, when the showcase or the like is used as the storage areas, the user 104 confirms the target merchandise while viewing the showcase or the like, purchases the target merchandise online, thereby being capable of directly obtaining the merchandise.

The present invention is not limited to the above respective embodiments, but includes various modifications. For example, in the abovementioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions, processors, and processing means may be realized, for example, as an integrated circuit, or other hardware.

Also, the above respective configurations and functions may be realized by software by allowing the processor to interpret and execute programs for realizing the respective functions. The information on the program, table, and file for realizing the respective functions can be stored in a storage device such as a nonvolatile semiconductor memory, a hard disk drive, or an SSD (Solid State Drive), or a computer-readable non-temporary data storage medium such as an IC card, an SD card, or a DVD.

Also, the control lines and the information lines necessary for description are illustrated, and all of the control lines and the information lines necessary for products are not illustrated. In fact, it may be conceivable that most of the configurations are connected to each other.

What is claimed is:

1. A storage area management system comprising:
a storage unit that holds storage area information on positions of a plurality of storage areas and user information on action characteristics of a plurality of users;
a storage area extraction unit that extracts a plurality of storage areas available for the respective users on the basis of the action characteristics of the plurality of users and the plurality of storage areas;
a placement position determination unit that determines a storage area in which merchandise predicted to be purchased by each of the users is placed from the plurality of storage areas available for the respective users; and
a delivery instruction creation unit that creates and transmits an instruction for delivering the merchandise predicted to be purchased by each of the users to the storage area determined by the placement position determination unit.

2. The storage area management system according to claim 1,
wherein the storage unit further holds merchandise information indicative of sizes of the respective merchandise,
the storage area information includes information indicative of sizes of the respective storage areas and the amounts of the respective merchandise that have already been placed in the respective storage areas,
the storage area extraction unit extracts a storage area group including the storage area available for each of the users from a plurality of storage area groups each of which includes the plurality of storage areas as a storage area group in which the merchandise predicted to be purchased by each of the users is to be placed,
the storage area management system further comprises a placement merchandise extraction unit that determines the amount of each piece of merchandise placed in each of the storage area groups in a state where a total of the sizes of all the merchandise placed in each of the storage area groups does not exceeds a total of the sizes of all the storage areas included in each of the storage area groups, on the basis of the size of each piece of merchandise to be placed in each of the storage area groups and the size of each storage area included in each storage area group, and
the placement position determination unit determines the storage area in which each piece of merchandise is placed in a state where the merchandise of the amount determined by the placement merchandise extraction is dispersed and placed in the plurality of storage areas included in the respective storage area groups.

3. The storage area management system according to claim 2,
wherein the placement position determination unit determines the storage area in which each piece of merchandise is placed in a state where the merchandise predicted to be purchased by a larger number of users is placed in the storage areas available for the larger number of users.

4. The storage area management system according to claim 1,
wherein the action characteristics of the plurality of users include residences of the plurality of users, and
the storage area extraction unit determines whether the respective storage areas are available for the respective users, on the basis of a relationship between the residences of the respective users and the positions of the respective storage areas.

5. The storage area management system according to claim 4,
wherein the action characteristics of the plurality of users further include stop destinations of the plurality of users, and
the storage area extraction unit determines whether the respective storage areas are available for the users, so that the storage area in a direction closer to a direction from the residence of each user to the stop destination of each user among the plurality of storage areas is determined to be more available.

6. The storage area management system according to claim 1,
wherein the user information further includes information on the action histories of the plurality of users, and
the storage area management system further includes a purchasing prediction unit that predicts the merchandise purchased by each user on the basis of the action history of each user.

7. The storage area management system according to claim 6,
wherein the action histories of the plurality of users include purchase histories of the respective pieces of merchandise of the plurality of users, and
the storage area management system further comprises a data receiving unit that receives an order for purchasing the merchandise from each user, and updates the user information on the basis of the received order.

8. The storage area management system according to claim 7, further comprising a state receiving unit that updates the storage area information on the basis of information indicative of a variation of the amount of merchandise located in each of the storage areas,
wherein the delivery instruction creation unit creates and transmits an instruction for adding each piece of merchandise to the storage areas, taking over the merchandise, or transferring each piece of merchandise between the storage areas so as to eliminate a deviation when the deviation between a prediction by the purchasing prediction unit and a purchase history by each user of each piece of merchandise specified from the updated storage area information, or the deviation between a past prediction by the purchasing prediction unit and a prediction by the purchasing prediction unit based on the order newly received satisfies a predetermined condition.

9. The storage area management system according to claim 6,
wherein the action histories of the plurality of users include histories of accesses of the plurality of users to the information on each piece of merchandise in a purchase site of each piece of merchandise,
the purchasing prediction unit predicts that the user purchases the purchase when the history of an access of any user to information on any merchandise satisfies a predetermined condition,
the delivery instruction creation unit creates and transmits an instruction for placing the merchandise in the storage area available for the user when the merchandise is not placed in the storage area available for the user, and
the storage area management system further comprises an output unit that outputs the information indicative of the storage area in which the merchandise is placed to the user after the merchandise is placed in the storage area available for the user.

10. The storage area management system according to claim 1, further comprising:
a data receiving unit that receives the order for purchasing the merchandise from each of the users;
a search unit that searches the storage area in which the ordered merchandise is placed, and which is available for the ordering user, from the storage area information; and
an output unit that outputs information on the searched storage area.

11. The storage area management system according to claim 1, further comprising:
a search unit that searches the storage area in which the merchandise browsed by the user is placed and which is available for the user from the storage area information when a time during which any user browses information on any merchandise on an on-line site providing merchandise information to the plurality of users exceeds a predetermined standard; and
an output unit that outputs the information on the searched storage area.

12. The storage area management system according to claim 1,
wherein the plurality of storage areas include at least any one of a backyard of a shop, a showcase without the shop, a vending machine, and a locker.

13. A storage area management system including a processor and a storage device connected to the processor,
wherein the storage device holds storage area information on positions of a plurality of storage areas and action characteristics of a plurality of users, and
the processor extracts a plurality of storage areas available for each of the users on the basis of the action characteristics of the plurality of users and the positions of the plurality of storage areas, determines a storage areas in which merchandise predicted to be purchased by each of the users is placed, from the plurality of storage areas available for each of the users, and creates and transmits an instruction for delivering the merchandise predicted to be purchased by each of the users to the determined storage area.

14. A storage area management method executed by a computer system including a processor and a storage device connected to the processor,
wherein the storage device holds storage area information on positions of a plurality of storage areas and action characteristics of a plurality of users,
the storage area management method comprising the steps of:
extracting a plurality of storage areas available for each of the users on the basis of the action characteristics of the plurality of users and the positions of the plurality of storage areas by the processor;
determining a storage area in which merchandise predicted to be purchased by each of the users is placed, from the plurality of storage areas available for each of the users by the processor; and
creating and transmitting an instruction for delivering the merchandise predicted to be purchased by each of the users to the determined storage area by the processor.
